(19) United States
(12) Patent Application Publication
(10) Pub. No.: US 2013/0240439 A1
(43) Pub. Date: Sep. 19, 2013

(54) REDUCED GRAPHENE OXIDE-BASED-COMPOSITES FOR THE PURIFICATION OF WATER

(71) Applicants: Thalappil Pradeep, Chennai (IN); Shihabudheen Mundampra Maliyekkal, Kerala (IN); Sreeprasad Theruvakkattil Sreenivasan, Kerala (IN)

(72) Inventors: Thalappil Pradeep, Chennai (IN); Shihabudheen Mundampra Maliyekkal, Kerala (IN); Sreeprasad Theruvakkattil Sreenivasan, Kerala (IN)

(73) Assignee: INDIAN INSTITUTE OF TECHNOLOGY, Chennai (IN)

(21) Appl. No.: 13/820,403

(22) PCT Filed: Sep. 2, 2011
(86) PCT No.: PCT/IB11/02740

§ 371 Date: May 14, 2013

(30) Foreign Application Priority Data
Sep. 3, 2010 (IN) 2563/CHE/2010

(51) Int. Cl. B01J 20/10; B01J 20/06; C02F 1/28

(52) U.S. Cl. CPC B01J 20/103; C02F 1/281; B01J 20/06
USPC 210/502.1; 252/178; 252/175; 252/176; 428/457; 428/472.2; 428/464; 428/458

(57) ABSTRACT

A nanocomposite is disclosed comprising reduced graphene oxide (RGO) and at least one of a metal and an oxide of the metal. Also disclosed is an adsorbent comprising the nanocomposite and an adsorbent comprising the nanocomposite bound to silica by using chitosan. A filtering device comprising the nanocomposite and/or the adsorbent is also disclosed. Also disclosed are methods for producing the nanocomposites, adsorbents, and filtering devices described herein.

### BACKGROUND

1. Technical Field

The present disclosure relates to nanocomposites, and specifically to graphene-based nanocomposites.

2. Technical Background

Chemical waste generated during industrial, domestic and agricultural activities continues to contaminate water. In addition to contaminants generated by human activities, the presence of natural contaminants in water sources also poses a great hazard.

Various technologies have been invented to mitigate the problem of water pollution. Various processes including adsorption, precipitation, membrane separation, amalgamation, and ion-exchange have been adopted and developed for separating waste materials from polluted water. Among all such processes, adsorption has been proven to be more economical and efficient, especially for removing pollutants from dilute solutions. Numerous adsorbents have been developed for separating pollutants from water. The efficacy and utility of adsorbents largely depend on the affinity of target contaminants towards the adsorbents and economic viability of the adsorbents. Carbon is one such adsorbent, which has been extensively used and found to be efficient in removing variety of pollutants present in water, be it organic or inorganic pollutants. However, to meet the increasingly stringent standards of the quality of drinking water, constant efforts are being carried out to identify better adsorbents.

Nanomaterials are a fairly new class of materials that offer great opportunities in water purification as adsorbents. As a result, researchers have focused on nanotechnology to develop efficient, cost effective and eco-friendly methods to decontaminate water.

Recently, a new class of carbon based nanomaterials, viz. reduced graphene oxide (RGO) composites, is being investigated for water purification. RGO and its precursor, graphite oxide (GO), are used in various applications including water purification, due to their unique two-dimensional nature, band structure, large surface area and various functional groups. Many composite materials are known to show superior properties compared to the properties of their individual components. This is can be due to synergetic properties that can arise from the combination of the materials. Carbon based composites are reported to show enhanced properties. Various composites of metal oxide and carbon materials such as activated carbon, graphite, and carbon nanotubes are being made for various applications. GO and RGO sheets are other interesting carbon based materials for making composites. Compared to GO, RGO composites are fewer in number.

The above-mentioned composites have been proposed for either catalytic or electronic applications. Recent efforts also show that graphene composites, such as graphene-Fe₃O₄ and GO-Fe (OH)₃ can be efficient in the removal of arsenic from water.

The methodologies adopted in most of the previous methods for composite formation are relatively cumbersome. The metal precursor is separately prepared and mixed; or external aids are employed for the production of composites. Vacuum filtration is one such method used for the preparation of RGO-Au composites. A RGO-Ag composite has also been produced through a one-step chemical method at 75° C., where GO or RGO is adsorbed on 3-aminopropyltriethoxysilane (APTES)-modified Si/SiOₓ substrate and the sample is heated in an aqueous solution of silver nitrate at 75° C.

Apart from efficacy, other important aspects of practical adaptability of materials for large-scale applications of water purification are cost and ease of operation. Though nanomaterials offers a great efficacy over their counter parts, one of the problems in using nanomaterials for water purification is post-treatment handling of the adsorbent material. Easy solid-liquid separation without any external aid is desirable.

Thus, there exists a need to address the aforementioned problems and other shortcomings associated with the traditional materials and composites that are used in water purification. These needs and other needs are satisfied by the compositions and methods of the present invention.

### SUMMARY

In accordance with the purpose(s) of the invention, as embodied and broadly described herein, this disclosure, in one aspect, relates to nanocomposites, such as, for example, reduced graphene oxide (RGO)-metal/metal oxide nanocomposites, methods of making nanocomposites, and to the use of such nanoparticles in water purification methods, such as, for example, removal of heavy metals from water.

In one aspect, the present disclosure provides a nanocomposite. The nanocomposite comprises reduced graphene oxide (RGO) and nanoparticles of at least one of a metal and an oxide of the metal. The metal comprises at least one of gold, silver, platinum, palladium, cobalt, manganese, iron, tellurium, rhodium, ruthenium, copper, iridium, molybdenum, chromium and cerium.

In another aspect, the present disclosure provides an adsorbent comprising a nanocomposite. The nanocomposite comprises reduced graphene oxide (RGO) and nanoparticles of at least one of a metal and an oxide of the metal. The metal comprises at least one of gold, silver, platinum, palladium, cobalt, manganese, iron, tellurium, rhodium, ruthenium, copper, iridium, molybdenum, chromium and cerium.

In yet another aspect, the present disclosure provides an adsorbent comprising a nanocomposite. The nanocomposite comprises reduced graphene oxide (RGO) and nanoparticles of at least one of a metal and an oxide of the metal. The metal comprises at least one of gold, silver, platinum, palladium, cobalt, manganese, iron, tellurium, rhodium, ruthenium, copper, iridium, molybdenum, chromium and cerium. The nanocomposite is further bound to a substrate.

In still another aspect, the present invention provides a filtering device comprising an adsorbent. The adsorbent comprises a nanocomposite. The nanocomposite comprises reduced graphene oxide (RGO) and nanoparticles of at least one of a metal and an oxide of the metal. The metal comprises at least one of gold, silver, platinum, palladium, cobalt, manganese, iron, tellurium, rhodium, ruthenium, copper, iridium, molybdenum, chromium and cerium. The nanocomposite is further bound to a substrate.

In still another aspect, the present disclosure provides a versatile in-situ method of making a nanocomposite using the ability of reduced graphene oxide (RGO) to reduce a metal precursor. The method comprising any one or more of the steps disclosed herein.

Various aspects, as described in the foregoing, provide nanocomposites and a method for synthesizing mono-dispersed and uncapped nanoparticles such as silver, gold, platinum, palladium and manganese oxide on the surface of RGO. The method facilitates in-situ homogenous reduction and utilizes the inherent reducing ability of RGO to produce composite materials, at room temperature. The methodology permits the production of large-scale RGO nanocomposites with good control over the particle size, which is critical for mass applications such as water purification.

The GO/RGO-metal/metal oxide nanocomposites can be further bound on silica. The resulting adsorbent composition helps in easy separation of the adsorbent from an aqueous medium and eliminates the need for otherwise laborious processes such as high speed centrifugation, membrane filtration, or magnetic separation, which are not practical for many end-users.

Additional aspects and advantages of the invention will be set forth, in part, in the detailed description and any claims which follow, and in part will be derived from the detailed description or can be learned by practice of the invention. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### BRIEF DESCRIPTION OF THE FIGURES

The accompanying figures, which are incorporated in and constitute a part of this specification, illustrate several aspects and together with the description serve to explain the principles of the invention.

FIG. 1 illustrates UV/Vis spectra of RGO upon the addition of metal ions (A) KMnO₄, (B) Au₃+, (C) Ag+, and (D) Pt₂+, in accordance with various aspects of the present disclosure.

FIG. 2 illustrates large area TEM images of RGO showing the characteristic wrinkles and edges of ˜1 nm confirming the graphenic nature of the sample, in accordance with various aspects of the present disclosure.

FIG. 3 illustrates TEM images of RGO-Ag (0.05 mM) showing well dispersed nanoparticles over a RGO sheet, in accordance with various aspects of the present disclosure.

FIG. 4 illustrates TEM images of A) 0.01 mM, B) 0.02 mM, C) 0.07 mM RGO-Au sample, and D) SEM image of an aggregated sample (0.1 mM) of RGO-Au, in accordance with various aspects of the present disclosure.

FIG. 5 illustrates A) TEM image of the RGO-Pt sample containing 0.02 mM H₂PtCl₄, B) lattice resolved image of the same sample showing the lattice structure of Pt nanoparticles, C) and D) SEM images taken from the aggregated sample of higher concentration (0.1 mM), in accordance with various aspects of the present disclosure.

FIG. 6 illustrates SEM images of RGO-Pd samples: A) 0.025 mM and B) 0.1 mM of PdCl₂ and C) EDS spectrum taken from the sample containing 0.1 mM PdCl₂, in accordance with various aspects of the present disclosure.

FIG. 7 illustrates concentration dependent TEM images of A1) 0.01 mM, A2) 0.025 mM and A3) 0.05 mM RGO-MnO₂, and B1) 0.01 mM, B2) 0.025 mM and B3) 0.05 mM RGO-Ag, in accordance with various aspects of the present disclosure.

FIG. 8 illustrates Raman spectrum of RGO-MnO₂ sample showing the presence of MnO₂ in the composite, in accordance with various aspects of the present disclosure.

FIG. 9 illustrates Raman spectra of A) RGO-MnO₂ composite and B) RGO-Ag composite, at different loading of MnO₂ and Ag, in accordance with various aspects of the present disclosure.

FIG. 10 illustrates XPS spectra of samples containing 1) 0.025 mM, 2) 0.05 mM and 3) 0.1 mM KMnO₄, in accordance with various aspects of the present disclosure.

FIG. 11 illustrates XPS spectra of RGO-Ag composites, in accordance with various aspects of the present disclosure.

FIG. 12 illustrates SEM Images of A) Ch-RGO-Ag@SILICA; B) Ch-RGO-MnO₂@SILICA; C) Raman spectrum of SILICA, Ch, Ch-RGO-MnO₂@SILICA and Ch-RGO-Ag@SILICA; and D) Photograph of SILICA, Ch-RGO-MnO₂@SILICA and Ch-RGO-Ag@SILICA, in accordance various aspects of the present disclosure.

FIG. 13 illustrates EDAX analysis of Ch-RGO-Ag@SILICA composite, in accordance with various aspects of the present disclosure.

FIG. 14 illustrates EDAX analysis of Ch-RGO-MnO₂@SILICA composite, in accordance with various aspects of the present disclosure.

FIG. 15 illustrates A) comparison of Kd values obtained for the adsorption of Hg(II) of unsupported RGO composites with different materials examined, B) comparison of Kd values obtained for the adsorption of Hg(II) of supported RGO composite with SILICA, Ch, Ch@SILICA, C) kinetics of Hg(II) adsorption by various adsorbents (temperature=30±2oC; pH=7±0.2, initial Hg(II) conc.=1 mg/L), and D) performance comparison of RGO composites for removing Hg(II) from distilled water and real water (initial Hg(II) conc.=˜1 mg/L, in accordance with various aspects of the present disclosure.

FIG. 16 illustrates pseudo-first-order kinetic plots with experimental data for adsorption of Hg(II) by GO, RGO and various RGO composites (E—experimental, P—predicted) in A) unsupported and B) supported form, in accordance with various aspects of the present disclosure.

FIG. 17 illustrates selectivity of adsorption of RGO-Ag for the indicated metal ions at three different initial concentrations (˜1, 2 and 5 mg/L), in accordance with various aspects of the present disclosure.

### DETAILED DESCRIPTION OF THE INVENTION

The present invention can be understood more readily by reference to the following detailed description of the invention and the examples included therein.

Before the present compounds, compositions, articles, systems, devices, and/or methods are disclosed and described, it is to be understood that they are not limited to specific methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

### DEFINITIONS

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a solvent” may include mixtures of two or more solvents.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or cannot occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

As used herein, the term “graphite material” refers to any material that comprises graphite. The term “graphite” refers to any form of graphite, including without limitation natural and synthetic forms of graphite, including, for example, crystalline graphites, expanded graphites, exfoliated graphites, and graphite flakes, sheets, powders, fibers, pure graphite, and graphite. When graphite is present, one or more graphitic carbons can have the characteristics of a carbon in an ordered three-dimensional graphite crystalline structure including layers of hexagonally arranged carbon atoms stacked parallel to each other. The presence of a graphitic carbon can be determined by X-ray diffraction. As defined by the International Committee for Characterization and Terminology of Carbon (ICCTC, 1982), and published in the Journal Carbon, Vol. 20, p. 445, a graphitic carbon can be any carbon present in an allotropic form of graphite, whether or not the graphite has structural defects.

As briefly described above, the present disclosure relates to a material comprising RGO-metal/metal oxide nanocomposites. The composites are prepared by a simple redox reaction between RGO and a metal precursor using inherent reducing ability of RGO. In one aspect, the GO/RGO/RGO-composites are supported on silica. Chitosan, an abundantly available and environment-friendly biomaterial, can be used as a binder for this process.

### RGO-Metal/Metal-Oxide Nanocomposites

In one aspect, a nanocomposite of the present invention may comprise composites of GO/RGO with suitable metal/metal-oxide nanoparticles. Metals that can be incorporated into the nanocomposite include, without limitation, gold, silver, platinum, palladium, cobalt, manganese, iron, tellurium, rhodium, ruthenium, copper, iridium, molybdenum, chromium, cerium, or a combination thereof. Metal oxides that can be incorporated into the nanocomposite include, without limitation, MnO₂ and the like. Exemplary nanocomposites can correspond to the formulas RGO-Ag, RGO-Au, RGO-Pt, RGO-Pd, RGO-Fe, RGO-Rh, RGO-MnOₓ, RGO-CoO, RGO-Te0₂, RGO-Ce₂O₃, RGO-Cr₂O₃ and combinations thereof.

The composition of a nanocomposite—RGO-metal/metal-oxide—can include various compositional ratios of the ingredients in the formula. It should be appreciated that the composition of such a nanocomposite can be tuned by adjusting the relative amounts of each ingredient, for example, RGO and metal/metal oxide, during a redox reaction. The concentration of participating ingredients in the reaction is varied leading to a variation in the diameter of the metal/metal oxide nanoparticles in the nanocomposite from 1-100 nm, and more specifically in the range of 3-10 nm.

The nanocomposites of the present invention can be prepared by a variety of methods. It should be understood that the specific order of steps and/or contacting components in the recited methods can vary, and the present invention is not intended to be limited to any particular order, sequence, or combination of individual components or steps. One of ordinary skill in the art, in possession of this disclosure, could readily determine an appropriate order or combination of steps and/or components to produce a nanocomposite.

A graphite material can be oxidized to obtain graphene oxide (GO). In one aspect, the graphite material can be any material that comprises any form of graphite obtained from various naturally occurring materials ranging from fossil fuels to sugar. Graphite and carbon materials, such as those recited herein, are commercially available and/or can be produced by one of skill in the art in possession of this disclosure.

The complete oxidation of graphite can be ensured by preceding the actual oxidation by a pre-oxidation step. The pre-oxidized graphite can then undergo complete oxidation during the oxidation step to form GO.

The GO is then reduced to obtain RGO. In various aspects, the RGO can be prepared using any suitable chemical, physical, biological, photochemical or hydrothermal process known in the art.

Thereafter, the metal precursor is mixed with the RGO. In various aspects as described above, the metal precursor can comprise one or more of gold, silver, platinum, palladium, cobalt, manganese, iron, tellurium, rhodium, ruthenium, copper, iridium, molybdenum, chromium, cerium, or a combination thereof.

The reduction of the metal precursor can be carried in-situ by the inherent reducing properties of RGO, thereby leading to the formation of (RGO)-metal/metal oxide nanocomposites. In one aspect, a precursor of each of the desired metals to be present in the nanocomposite is mixed together with the RGO to form a nanocomposite. In other aspects, any one or more of the precursors are mixed together to form one or more mixtures. The mixture is then mixed with the RGO to form a nanocomposite.

In one aspect, the nanocomposite is prepared by mixing precursors of one or more of gold, silver, platinum, palladium, cobalt, manganese, iron, tellurium, rhodium, ruthenium, copper, iridium, molybdenum, chromium and cerium and an RGO.

In yet another aspect, at least two of the precursors of gold, silver, platinum, palladium, cobalt, manganese, iron, tellurium, rhodium, ruthenium, copper, iridium, molybdenum, chromium and cerium are mixed separate from any remaining components prior to mixing with an RGO.

In various above-mentioned aspects, the reduction of the metal precursor is carried at room temperature, such as, but not limited to, any temperature below about 40° C. In one aspect, the nanocomposite can be prepared by simultaneous reduction of metal/metal-oxide precursors and GO at room temperature. In another aspect, the nanocomposite can be prepared by mixing pre-formed metal/metal-oxide nanoparticles, such as, for example, titanium, zirconium, lanthanum, nickel, zinc, or a combination thereof and RGO at room temperature (below 40° C.).

In other aspects, each of the steps is performed in a different combination and/or different order. The specific methods of mixing, temperatures, and degree of mixing can vary depending upon the specific components and desired properties of the resulting nanocomposites.

In a specific aspect, one or more of the precursors of gold, silver, platinum, palladium, cobalt, manganese, iron, tellurium, rhodium, ruthenium, copper, iridium, molybdenum, chromium and cerium are mixed prior to mixing with RGO. In still another aspect, one or more precursor components, such as, for example, a silver precursor is mixed with a mixture of the remaining components. It should be noted that for any of the recited methods and variations thereof, it is not necessary that all of a precursor be mixed simultaneously and that one or more portions of any precursor can be mixed at a given time and the remaining portions be mixed at other times prior to, concurrent with, or subsequent to, any other step or mixing.

In another aspect, one or more of precursors of gold, silver, platinum, palladium, cobalt, manganese, iron, tellurium, rhodium, ruthenium, copper, iridium, molybdenum, chromium, titanium, zirconium, lanthanum, nickel, zinc and cerium and/or oxides thereof are mixed to form a mixture of metal/metal-oxide nanoparticles, and then the mixture is contacted and/or mixed with RGO.

The precursors for each component can vary and the present invention is not intended to be limited to any particular precursor materials. In one aspect, a precursor can comprise any compound containing the specific metal for which the compound is a precursor. For example, a silver precursor can comprise any silver containing compound; a manganese precursor can comprise any manganese containing compound; and a palladium precursor can comprise any palladium containing compound. One of skill in the art, in possession of this disclosure, could readily select an appropriate precursor material to produce a desired nanoparticle. For example, counter ions in the metal precursors may be chloride, nitrate, acetate, sulfate, bicarbonate, or any combination thereof. In such an aspect, ingredients for the metal precursor may comprise silver nitrate, chloroauric acid, potassium permanganate, PdCl₄, H₂PtCl₆, CrO₃, aquapentamine Co(III) chloride, rhodium trioxide, ruthenium dioxide, chromium trioxide or a combination thereof.

Other specific methods and combinations are recited herein and are intended to be included in the present invention, together with other unrecited combinations and variations.

In one aspect, one or more of the nanocomposites can comprise a uniform or substantially uniform composition. In such an aspect, the one or more nanocomposites having the same or substantially the same stoichiometry and chemical composition throughout the structure of the nanoparticles. In such aspect, small variations in stoichiometry and/or the presence of contaminants and/or impurities are not intended to render a portion of the nanocomposite as not uniform. In another aspect, one or more of the nanocomposites do not comprise a core having a different chemical composition than a remaining portion of the nanocomposites.

Nanocomposites and nanoparticles of the present invention can have any shape and size appropriate for a desired application, such as, for example, adsorbent for the removal of heavy metals from water. It should be appreciated that nanocomposite/nanoparticle shapes can depend on the mode of synthesis, as well as any post-treatment and/or aging. Thus, a variety of shapes are contemplated depending on the conditions under which a nanocomposite/nanoparticle is made and/or stored. Exemplary nanocomposites/nanoparticles can have shapes including, but not limited to, triangular, prism, tetragonal, rods, hexagonal, cubical, ribbon, tubular, helical, dendritic, flower, star, sheet or a combination thereof. In a specific aspect, at least a portion of the nanocomposites/nanoparticles comprise a triangular shape. In another aspect, at least a portion of the nanocomposites/nanoparticles comprise a prism or prismatic shape. In yet another aspect, at least a portion of the nanocomposites/nanoparticles comprise a tetragonal shape. In still further aspects, at least a portion of the nanocomposites/nanoparticles comprise a tetrahedron shape. In one aspect, all or a portion of the nanocomposites/nanoparticles do not comprise a flake. In other aspects, nanocomposites/nanoparticles can have a chalcopyrite structure. It should be appreciated that a given batch of nanocomposites can have a shape distribution (i.e. various nanocomposites/nanoparticles within a synthetic batch can comprise different shapes).

RGO-Metal/Metal Oxide Nanocomposites Bound with Silica

In one aspect, RGO-metal/metal oxide nanocomposites are immobilized on a supporting material or substrate, such as, but not limited to, silica. The resultant supported composite is used for the removal of heavy metal waste from water. In various aspects, the supporting material may further comprise alumina, zeolites, activated carbon, cellulose fibers, coconut fibers, clay, banana silks, nylon, coconut shell and a combination thereof. In one aspect, the RGO-metal/metal oxide nanocomposite may be bound to silica by using a suitable eco-friendly binding agent like chitosan. The binding agent may further comprise polyaniline, polyvinyl alcohol, polyvinylpyrrolidone (PVP), and a combination thereof.

### Water Purification Applications

As described in the foregoing, the RGO-metal/metal oxide nanocomposites can be used as an adsorbent composition for removing heavy metals from water. Examples of heavy metals include, but are not limited to, lead (Pb(II)) and manganese (Mn(II)), copper (Cu(II)), nickel (Ni(II)), cadmium (Cd(II)) and mercury (Hg(II)). Exemplary source of water can be any of a ground water source, an industrial source, a municipal source, water source and/or a combination thereof.

In one aspect, the adsorption composition can be used in batch set-up by mixing it with contaminated water. In another aspect, the adsorbent composition is used in a column setup by passing contaminated water through an adsorbent bed. In yet another aspect, the adsorbent composition is bound with a suitable supporting material such as, but not limited to, silica and the resultant composition can be used to treat contaminated water.

In various aspects, the adsorbent composition (with or without binding) is used to prepare a filter to remove heavy metals from contaminated water. The filter can be designed in variety of forms comprising a candle, a porous block (radial and/or vertical), a filter bed, a packet, a bag and the like.

### Other Applications

The nanocomposites of the present disclosure may also find potential applications in super capacitors, in organic reactions like Suzuki coupling, hydrogenation and de-hydrogenation reactions, and cracking of petroleum, catalysts for oxygen reduction reaction in fuel cells, hydrogen storage, and the like.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope, of what the inventors regard as their invention, in any way. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Preparation of RGO-Metal/Metal Oxide Nanocomposites

An exemplary GO synthesis from graphite powder was carried out based on the modified Hummers method reported by Kovtyukhova et al. (Hummers, W. S., Offeman, R. E., Preparation of graphitic oxide. J. Am. Chem. Soc. 1958, 80, 1339.; Kovtyukhova, N. I., Ollivier, P. J., Martin, B. R., Mallouk, T. E., Chizhik, S. A., Buzaneva, E. V., Gorchinskiy, A. D., Layer-by-layer assembly of ultrathin composite films from micron-sized graphite oxide sheets and polycations. Chem. Mater. 1999, 11, 771), contents of which are incorporated herein by reference. The volumes were scaled up to match the experimental requirements. Complete oxidation was ensured by preceding the actual oxidation by a pre-oxidation step. The pre-oxidized graphite undergoes complete oxidation during the oxidation step to form GO, the details of which have been reported by Kovtyukhova et al.

The GO reduction was carried out similar to a procedure reported by Li et al. (Li, D.; Muller, M. B., Gilje, S., Kaner, R. B., Wallace, G. G., Processable aqueous dispersions of graphene nanosheets. Nat. Nanotech. 2008, 3, 101), contents of which are incorporated herein by reference. Briefly, GO was exfoliated by sonication and hydrazine hydrate solution (35 wt % in water) was added and stirred. The solution was made alkaline by the addition of ammonia solution (28 wt % in water). The mixture was heated at 90° C. The reduction of GO to RGO happens in about 2 hours. This sample will be referred as purified reduced graphene oxide sheets (RGO).

25 mL of RGO was taken in a 50 mL beaker and calculated volumes of metal ion precursors (KMnO₄, HAuCl₄, AgNO₃, H₂PtCl₆, PdCl₂, etc.) were added such that the final concentration in the solution was 0.01, 0.025, 0.05, 0.1, 0.3 mM, etc. The mixture was incubated undisturbed for 12 h at 30° C. Later, all the solutions were put for dialysis against distilled water for 5 days. After dialysis, the samples were stored in glass bottles for further use, thereby producing the RGO-metal/metal oxide nanocomposites.

### 2. Binding RGO-Metal/Metal Oxide Nanocomposites to a Supporting Material

In order to support RGO composites on silica, the following protocol was adopted. Initially, as-prepared RGO-MnO₂/RGO-Ag and chitosan (Ch) solution (0.8% chitosan in 1.5% acetic acid) were mixed in 1:1 ratio. The mixture was stirred thoroughly to obtain a homogenous dispersion. 25 mL of the homogeneous dispersion was added to 10 g of silica and mixed thoroughly. The mixture was dried at about 40° C. under constant stirring to ensure uniform coating. To stabilize the coating, the dried samples were soaked in ammonia solution (35%) for about 1 hour and subsequently washed with distilled water until the pH of the washed water became nearly neutral. The materials were dried at 40° C. overnight and stored in glass bottles for further use.

### 3. Water Purification Demonstration

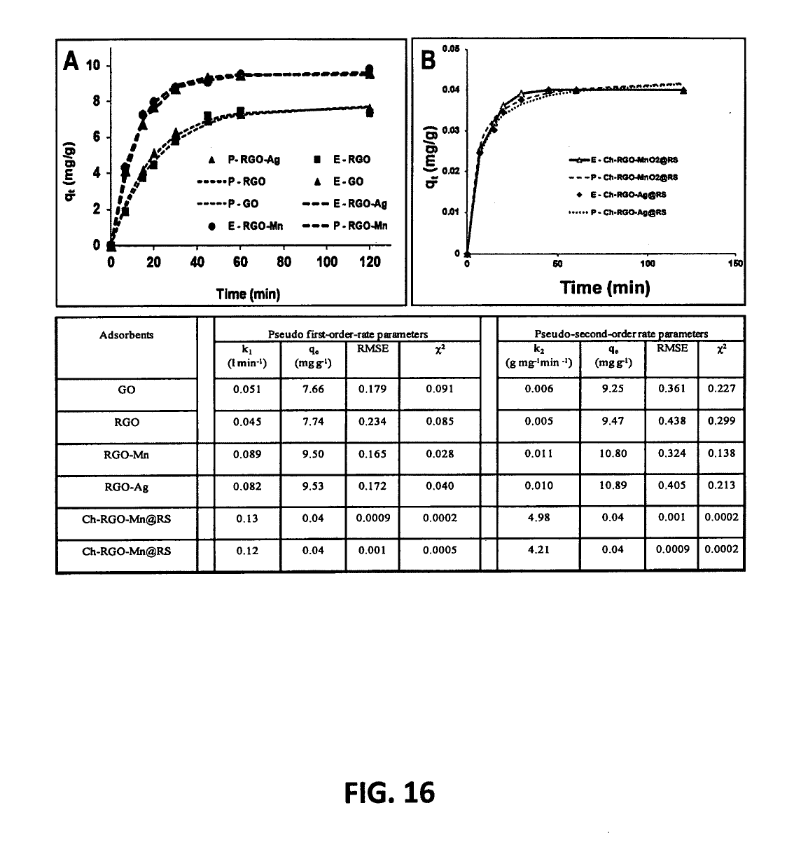

Two RGO-metal/metal-oxide compositions (RGO-MnO₂ and RGO-Ag), both in supported and unsupported form, were evaluated for their utility in the removal of Hg(II) from an aqueous medium. The Hg(II) uptake capacities of various other adsorbents, including RGO, activated carbon (AC), Ag impregnated carbon (AC-Ag), MnO₂ impregnated carbon (AC-MnO₂), silica, Chitosan (Ch) were compared with RGO-composites. Batch adsorption experiments were carried out in 20 mL glass bottles and the working volume was maintained as 10 mL. Homogenous adsorbent dispersion was taken in the reactor and the target pollutant was mixed into this solution to get the required concentration (1 mg/L) of Hg(II). For supported RGO composites immobilized on silica, 250 mg of the adsorbent was weighed and added to 10 mL of 1 mg/L of Hg(II) solution. In all the cases, solutions were kept for stirring at 30 (±2)° C. The samples were collected at predetermined time intervals and analyzed for residual mercury concentrations. The solid-liquid separation was done either by membrane filtration or by simple settling depending upon the adsorbents employed. The filtration protocol included filtering adsorbent dispersion through a 200 nm membrane filter paper (Sartorius Stedim™ biotech and biolab products) followed by 100 nm anodized filter paper (Whatman™ Schleicher™ and Schuell™). For conducting adsorption experiments in real water, the water was simulated by spiking ˜1 mg/L of Hg(II) into a groundwater. The water quality characteristics of ground water are given in Table 1 (illustrated in FIG. 16). In order to test the specificity of Hg(II) removal from the aqueous medium in presence of other heavy metals (Ni(II), Cd(II) and Cu(II)), selective metal ion adsorption tests were performed by using a mixture of aqueous solution of ˜1.0, 2.0 and 5.0 mg/L of each four metal ions, as illustrated by the procedure above. The residual metal ion concentrations present in solution were determined by using a PerkinElmer 5300 DV series Inductively Coupled Plasma (ICP-AES) Analyzer™.

### 4. Material Characterization

Surface morphology, elemental analysis and elemental mapping studies were carried out using a Transmission Electron Microscope (TEM) equipped with Energy Dispersive Analysis of X-rays (EDX) (INCA, Oxford Instruments™, UK). The sample prepared as mentioned above was drop casted on amorphous carbon films supported on copper grids and dried at room temperature. Samples were characterized using Scanning Electron Microscope (SEM) (FEI quanta 200TM) as well. The samples prepared as above were spotted on indium tin oxide (ITO) conducting glass and dried. High resolution Transmission Electron Microscopy (HRTEM) images of the sample were obtained with JEM 3010 (JEOL JEM 3010™, Japan). X-ray Photoelectron Spectroscopic (XPS) analysis was done using ESCA Probe TPDTM of Omicron Nanotechnology. Polychromatic Mg Kα was used as the X-ray source (hv=1253.6 eV). Spectra in the required binding energy range were collected and an average was taken. Beam induced damage of the sample was reduced by adjusting the X-ray flux. Binding energy was calibrated with respect to C 1s at 284.5 eV. UV/Vis spectra were measure using Lambda 25 spectrometer (Perkin-Elmer™, USA). Samples were characterized using Raman spectroscope also (WiTec GmbH CRM 200™, Germany)

5. Observations with Reference to Drawings

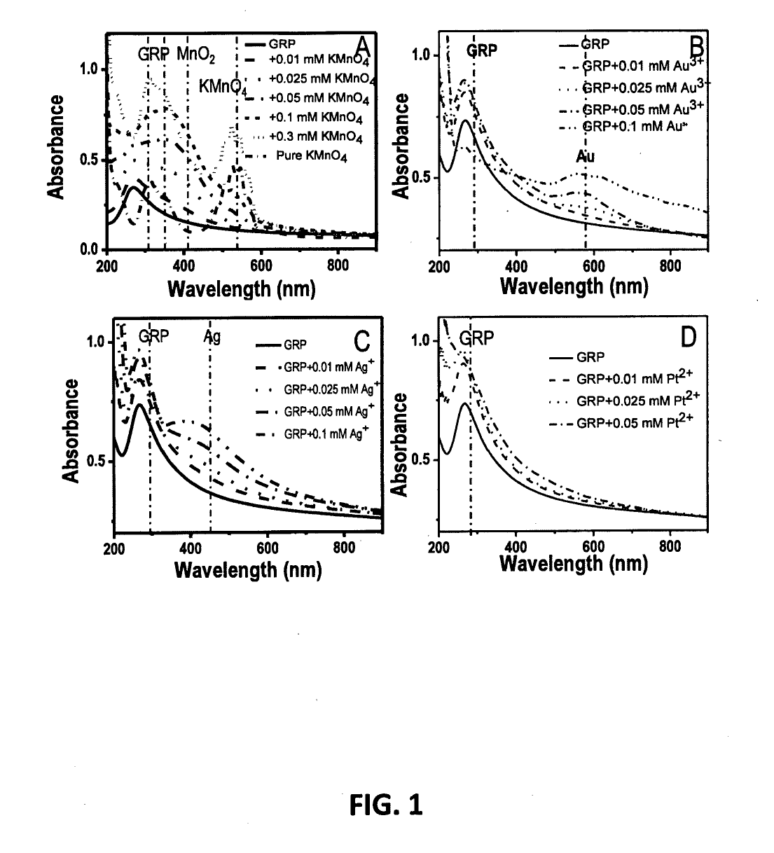

FIG. 1 shows the UV/Vis spectral changes accompanied by the addition of different metal ions to RGO suspensions. All spectra were collected after 12 hour of the addition of metal ion precursors. FIG. 1A show the spectral changes observed after the addition of KMnO₄ to RGO solution. At lower concentrations, there is no peak corresponding to KMnO₄ in the UV/Vis spectrum. The RGO peak at 270 nm as well as a broad peak characteristic of metal oxide, in this case MnO₂, can only be seen. A comparison of this peak with conventionally made MnO₂ nanoparticles confirms that the broad feature around 400 nm is due to the formation of MnO₂ nanoparticles. The spectral changes indicate the reduction of KMnO₄ to colloidal MnO₂ nanoparticles. The KMnO₄ feature at 565 nm begins to appear when the concentration of KMnO₄ added reaches 0.1 mM. This concentration onwards, the reduction is incomplete. There is a blue shift for the graphenic peak at 270 as the concentration of KMnO₄ added increases. This blue shift is an indication of the oxidation of RGO to GO. These results can be interpreted as the oxidation of graphene by KMnO₄, that makes GO and MnO₂. FIG. 1B-D show the UV/Vis spectral characteristics of the reduction of Au³⁺, Ag⁺ and Pt²⁺ by RGO. All the tested elements show blue shift in the RGO peak upon increasing the concentration of precursor ion added, pointing to oxidation of RGO.

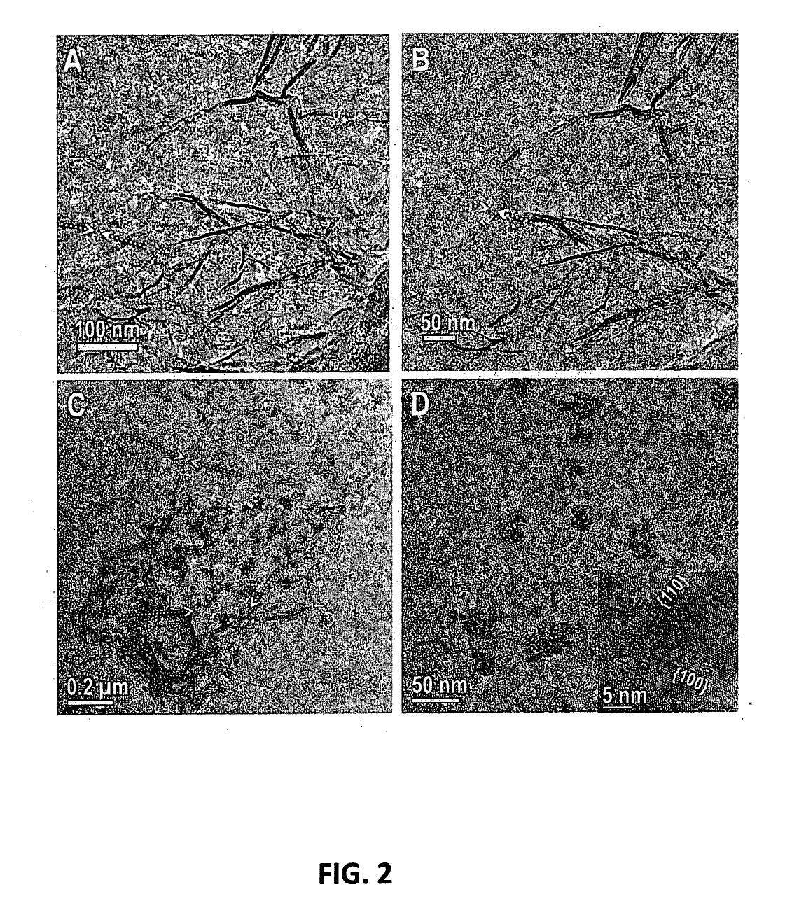

Large area TEM images of the as-synthesized RGO of FIG. 2 show wrinkled sheets characteristics of graphenic structures. The edges and wrinkles are measured to be around ˜1-1.5 nm, close to a bi-layer thickness. After the formation of the composites, structure of the RGO sheets remained the same (with wrinkles). We conclude that the composites are graphenic in nature with not more than two layers in thickness.

FIGS. 2C and 2D show the TEM images taken from the RGO-MnO₂ sample. Large islands of MnO₂ nanoparticles on the RGO sheets are seen and there are definite islands of nanoparticles of around 10 nm in size. Individual nanoparticles of smaller size regime (˜5 nm) are also seen. Inset of FIG. 2D shows a lattice resolved image of the nanoparticle formed. The lattice was indexed to {100} and {110} planes of δ-MnO₂ with a lattice spacing of 0.25 nm, and 0.14 nm, respectively.

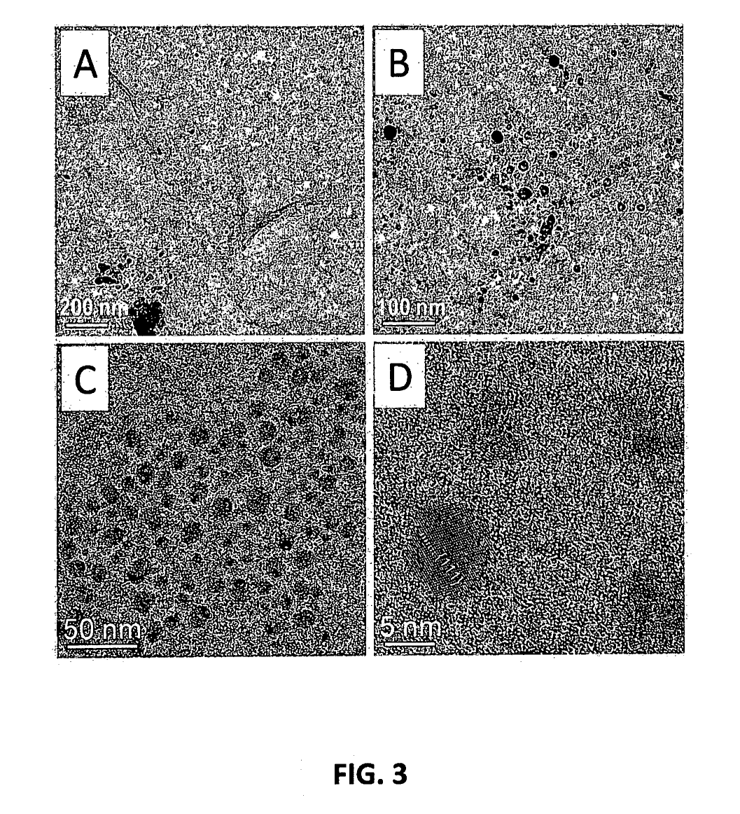

FIG. 3 shows the TEM micrographs of RGO-Ag sample. The particles are well separated, devoid of any aggregation in FIG. 3. Particles are in the size range of 10-15 nm. FIG. 3D shows a lattice resolved image of the nanoparticle. The formed nanoparticles are crystalline in nature. The {111} plane with a d-spacing of 0.235 nm characteristic of cubic Ag, is marked in the figure. Typical of the nature of Ag nanoparticles, some polydispersity was seen at places.

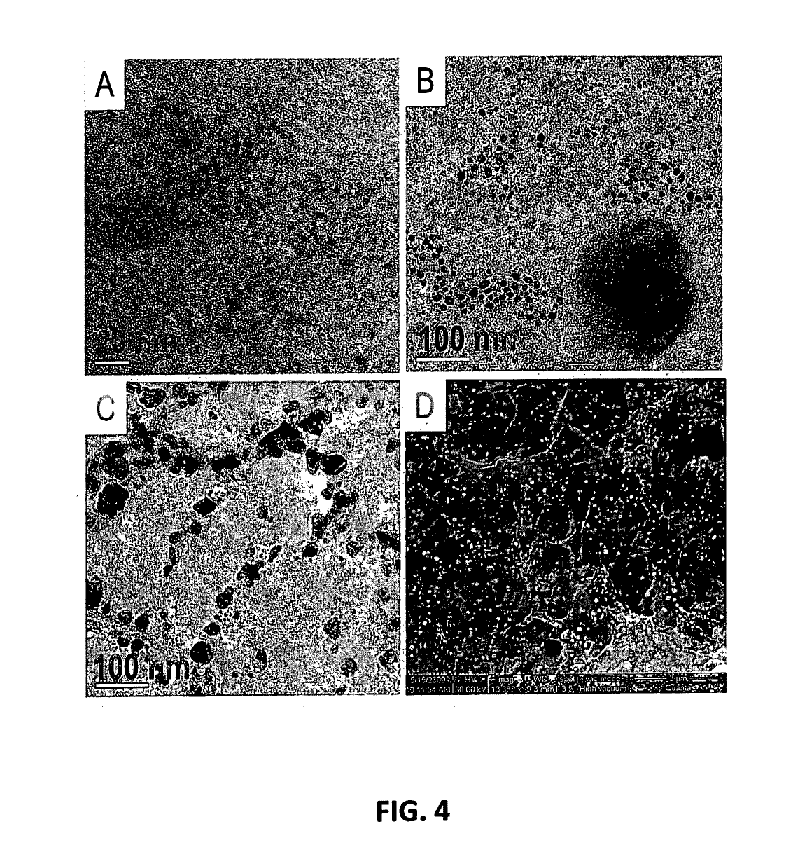

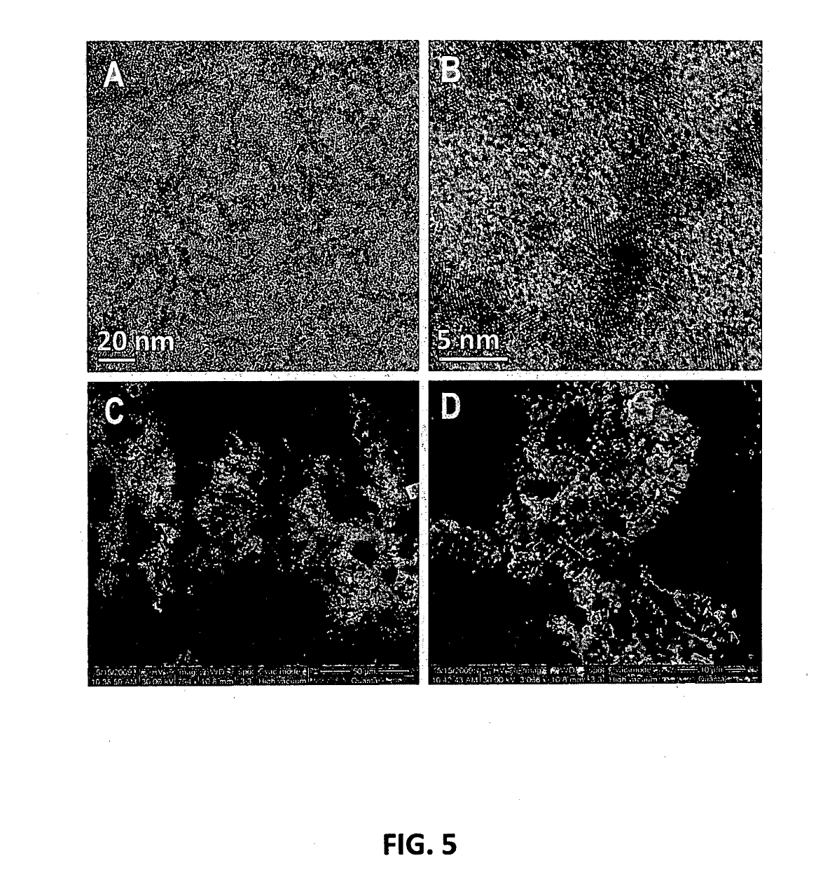

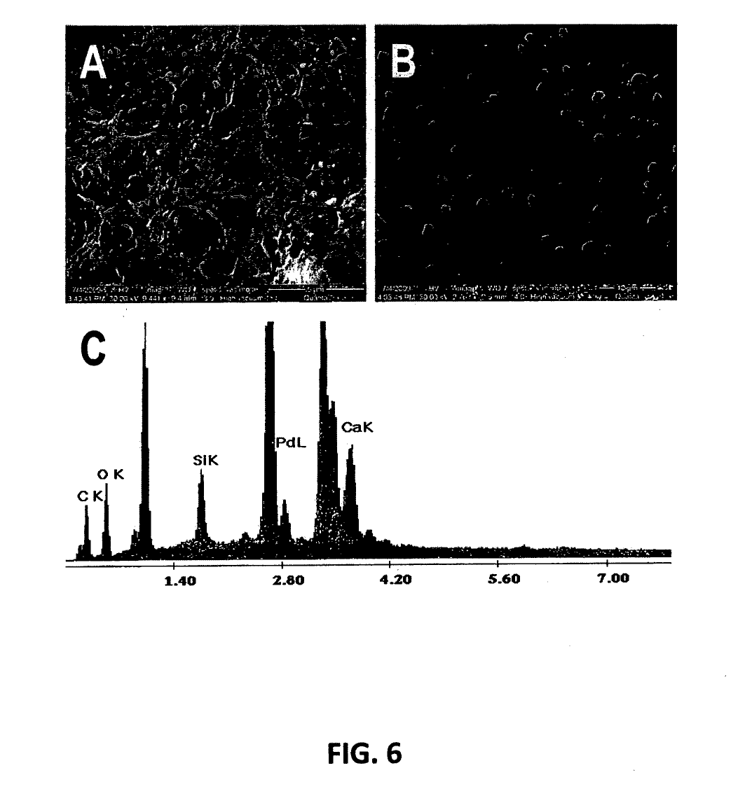

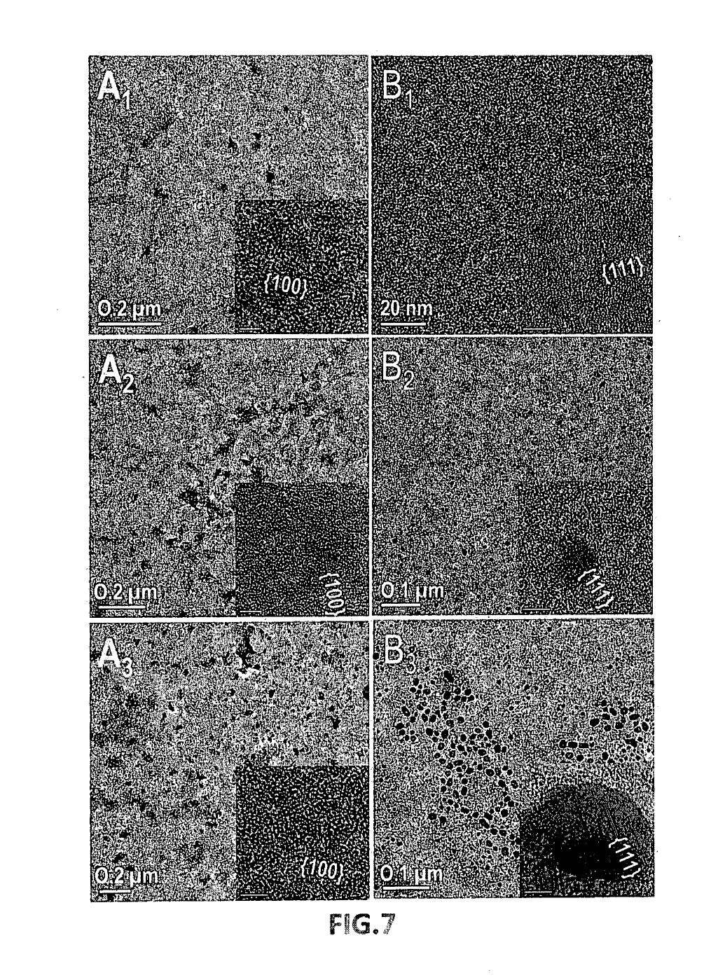

Similarly, composites containing Au, Pt, and Pd were prepared and characterized using various microscopic techniques and is shown in FIG. 4-6, respectively. At lower concentrations, the nanoparticles were mono-dispersed. However, as the concentration of the precursor was increased, the size of the nanoparticle formed increased and the sample became progressively polydispersed. At higher concentrations, though the sample showed aggregation, a considerable amount of nanoparticles are observed. In the case of Pt and Pd composites, the aggregation was largely due to precursor acidity, which can be controlled, to some extent, by adjusting the precursor pH to near neutral. Although, all the tested metals showed an increase in particle size with the increase in precursor concentrations (FIG. 4-6, FIG. 7B1-B3), a different behavior was observed in the case of RGO-MnO₂ composite. As the concentration of added KMnO₄ increased, the density of MnO₂ islands increased without much change in the particle size (FIG. 7A1-A3).

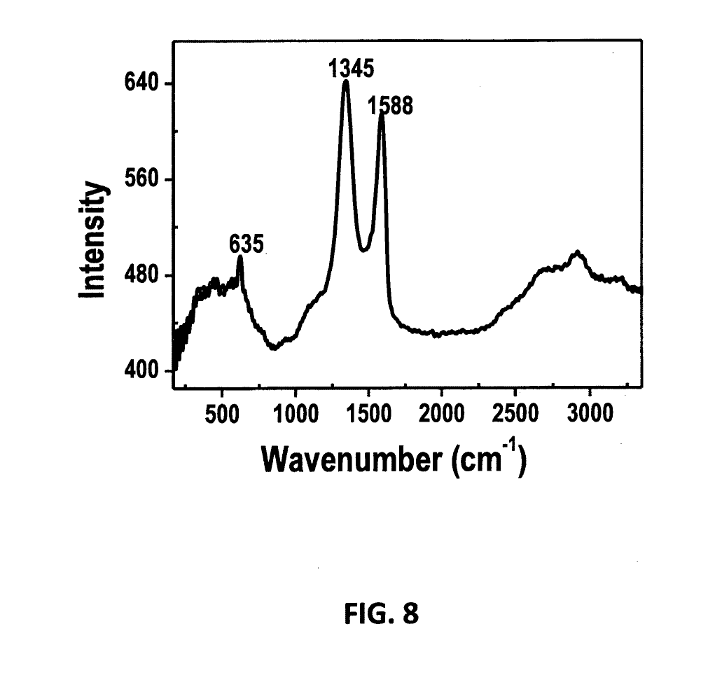

Raman spectrum of the composite showed features of RGO as well as (FIG. 8) MnO₂. The presence of Mn—O vibration at 632 cm-−1 confirmed the presence of MnO₂ in the composite and based on previous reports, the phase present may be δ-MnO₂. Raman features of δ-MnO₂ are comparatively weaker and the amount of MnO₂ presents in the composite being minimal; all the vibrations were not seen.

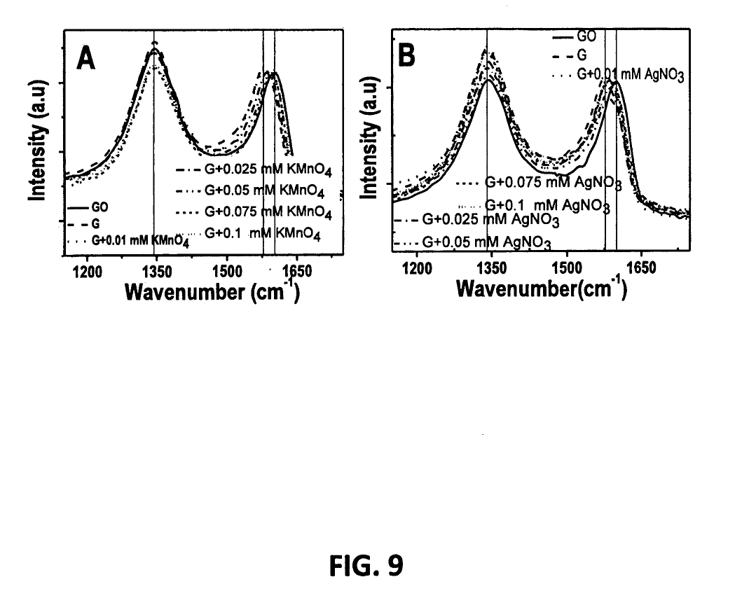

FIG. 9 shows the expanded view of the Raman spectra obtained from the composite, in the region of D- and G-band of graphene, having different metal content. In a typical synthesis, GO showed D-band at 1345 cm⁻¹ and G-band at 1598 cm⁻¹. After the reduction to RGO, the D-band remained the same but G-band shifted to lower frequency region and was observed at 1580 cm⁻¹. Both these positions are marked by vertical lines in the spectra. The Raman spectra of the composites showed interesting observations. From the spectra we can see that the D-band remained the same irrespective of the increase in KMnO₄ concentration (FIG. 9A), but the G-band underwent some changes. As the concentration of KMnO₄ increased, the G-band shifted to higher frequency region with respect to RGO. As the concentration reached 0.1 mM, the G-band position was more or less similar to that of GO implying the oxidation of graphene to GO by KMnO₄. This implies a redox-like reaction between RGO and KMnO₄ which results in the oxidation of RGO to GO and the reduction of KMnO₄ to MnO₂ nanoparticles. As the concentration of KMnO₄ increases, it uses up more RGO and gets converted to MnO₂. As a result, more and more RGO get oxidized and it is shown in the Raman spectrum by the blue-shift in the G-band with respect to RGO.

In the case of silver composite (FIG. 9B) similar change was observed. However, the extent of oxidation was less for the same concentration of metal content, as compared to that of KMnO₄. This is because of the fact that the reduction of Ag (+1) to Ag (0) requires less number of electrons compared the number of electrons required in the reduction of Mn (+7) to Mn (+4). Therefore, the corresponding oxidation happening to RGO will also be less.

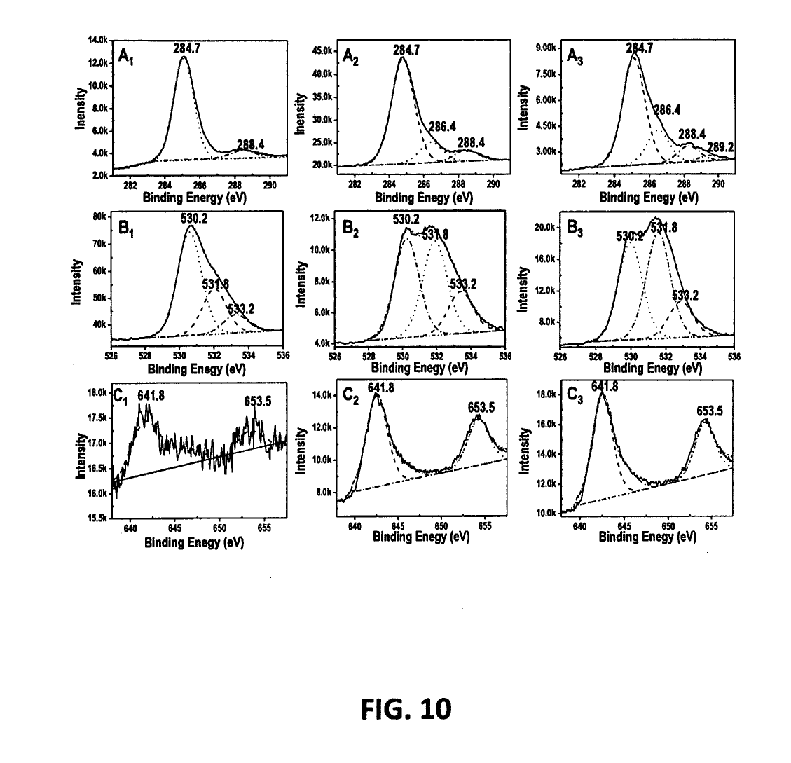

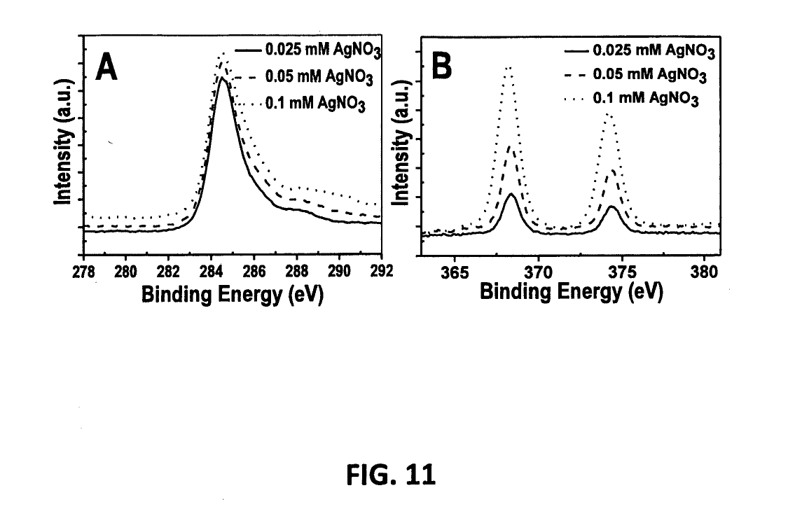

FIG. 10 shows the XPS spectra of samples containing different loadings of Mn. Upon increasing the precursor, KMnO₄ concentration, the feature of Mn in the spectra became more prominent, implying the reduction of KMnO₄ (FIG. 10 C1 to C3). In all the samples, Mn 2p3/2 peak was centered around 641.8 eV while the Mn 2p1/2 peak was around 653.5 eV. There was no feature observed around 647 eV corresponding to the Mn 2p3/2 signal of KMnO₄ confirming the complete reduction of KMnO₄ to MnO₂ nanoparticles. The AJ of 11.6 eV confirmed that the formed species is MnO₂. The corresponding oxidation was seen in carbon 1s and oxygen regions. In the first sample, the carbon spectrum had less extent of oxidation (FIG. 10A1). However, as the concentration of KMnO₄ added increased, the signatures of oxidation in carbon also increased. All oxygenated features increased in intensity as the concentration of KMnO₄ added into RGO increased. Similar trend was observed in the O 1s spectra as well. Upon deconvolution, each sample showed three components. First component centered around 530 eV. Metal oxides are known to show the O 1s feature around 530 eV. In all the samples analyzed, one component was always resolved around 530 eV confirming the presence of MnO₂ nanoparticle in the sample. Oxygen in carbonyl (C═O) and carboxylate functionalities (O═C—OH) in GO is also known to give features around 530 eV. The second component centered around 532 eV is reported to be due to the hydroxyl oxygen (C—OH) in graphene. The third component around 533 eV may be due to adsorbed water or due to C-0. Based on these observations, we propose a redox-like reaction in which the RGO is getting oxidized and KMnO₄ is getting reduced to MnO₂ nanoparticles. The RGO-Ag composite was also analyzed by XPS (FIG. 11). This also showed that as the concentration of AgNO₃ increased, the oxidation of carbon got increased. However, similar to the observation in Raman, the extent of oxidation was much less compared to the oxidation of MnO₂ composite, supporting our proposition. The metal composites were analyzed by EDX also. All the EDX spectra showed metal content and the corresponding imaging showed distribution of particles on the RGO sheets which had a one to one correspondence with the corresponding TEM images.

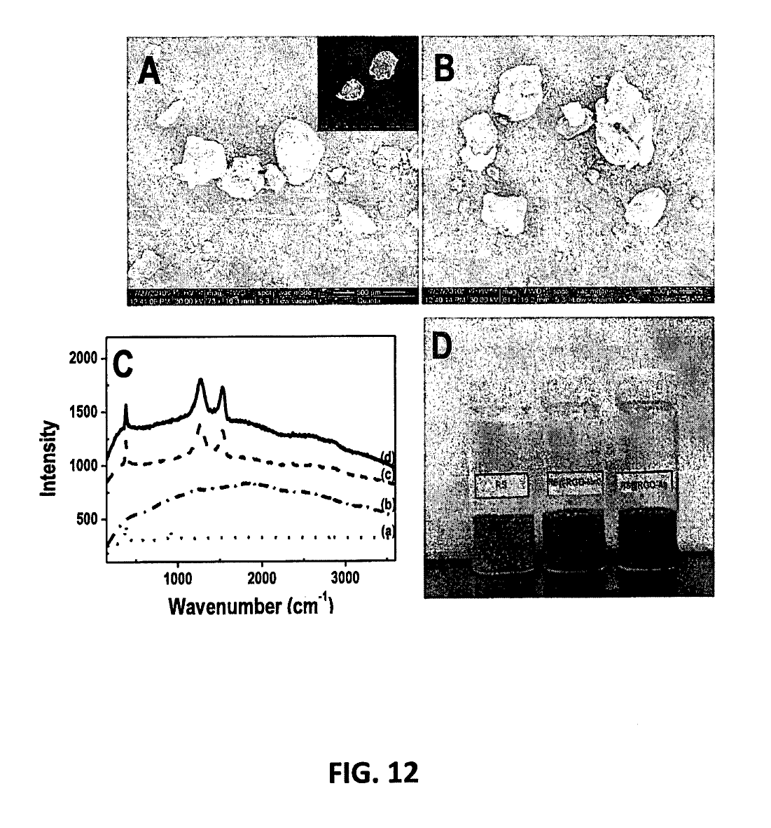

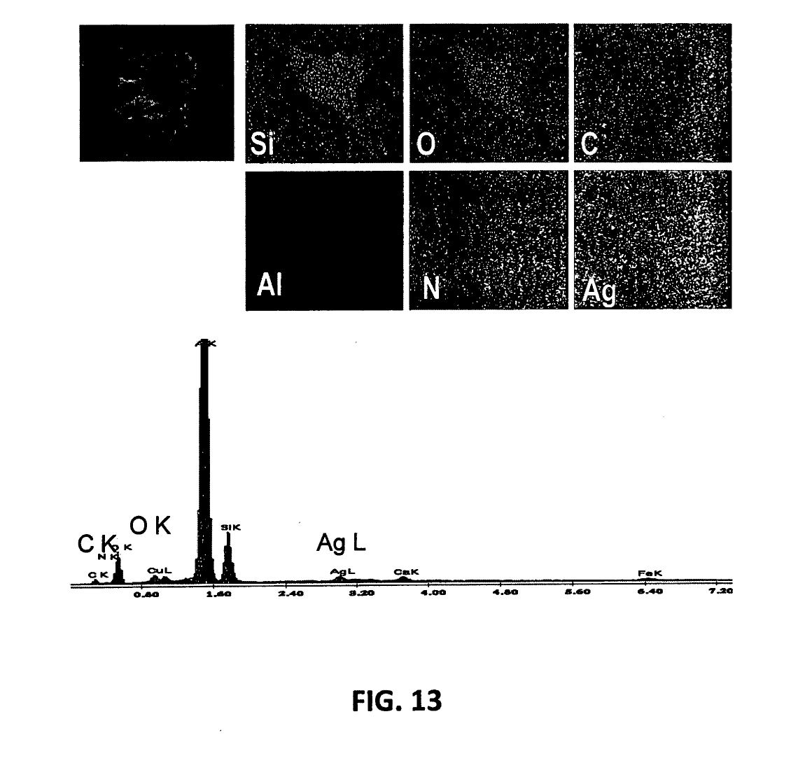

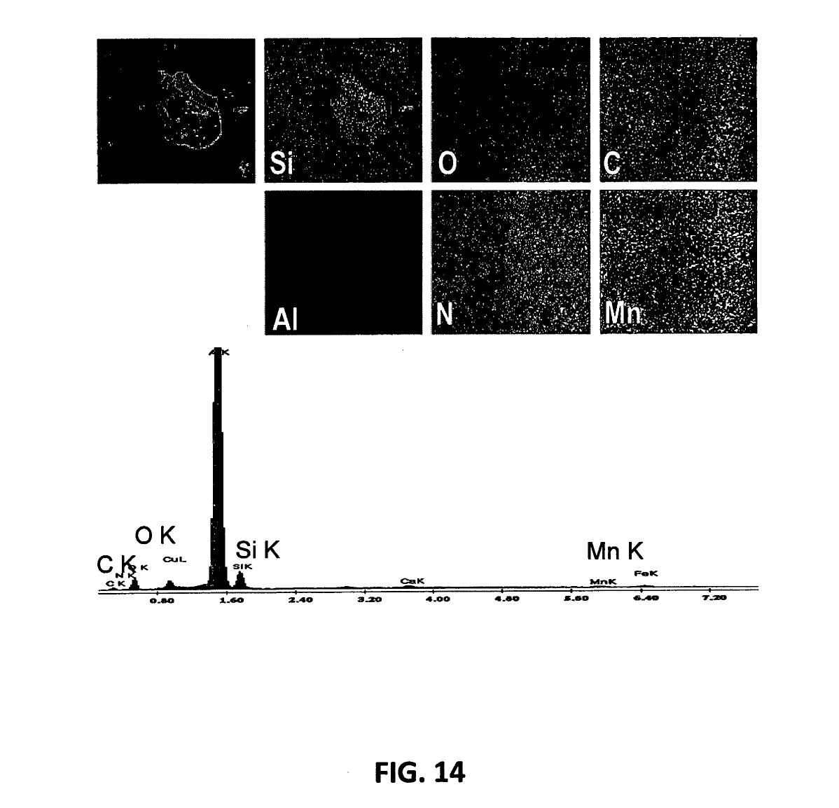

In order to employ any nanomaterials in the field for water purification, the materials have to be supported on suitable substrates. Here, RGO nanocomposites were supported on silica using chitosan as the binder. FIG. 12A shows the SEM images of Ch-RGO-Ag@SILICA. The particles are micrometers in size and can settle easily by sedimentation. Inset photograph shows the SEM image of virgin SILICA. FIG. 12B shows the SEM image of Ch-RGO-MnO₂@SILICA. EDAX analysis revealed the presence of Ag and MnO₂ on the surface of SILICA (FIGS. 13 and 14). The presence of chitosan was confirmed by the nitrogen signal in both composites. The supported composites were also characterized by Raman spectroscopy (FIG. 12C). All the composites showed a fluorescence background. This may be attributed to the presence of chitosan. The presence of Si—O bending (440 cm⁻¹) is observed. In all the above composites confirmed the presence of SiO₂. The clear features of RGO (broad D and G band) were evident in both Ch-RGO-MnO₂@SILICA and Ch-RGO-Ag@SILICA, indicating that RGO is effectively immobilized on SILICA surface. Characteristic of Mn—O (630 cm⁻¹) is observed. Vibration in Ch-RGO-MnO₂@SILICA confirms the presence of MnO₂ nanoparticles in the composite. Photograph in FIG. 12D shows clear change in color after the incorporation of composites. The color of SILICA changed from pale yellow to brown upon coating of RGO composites.

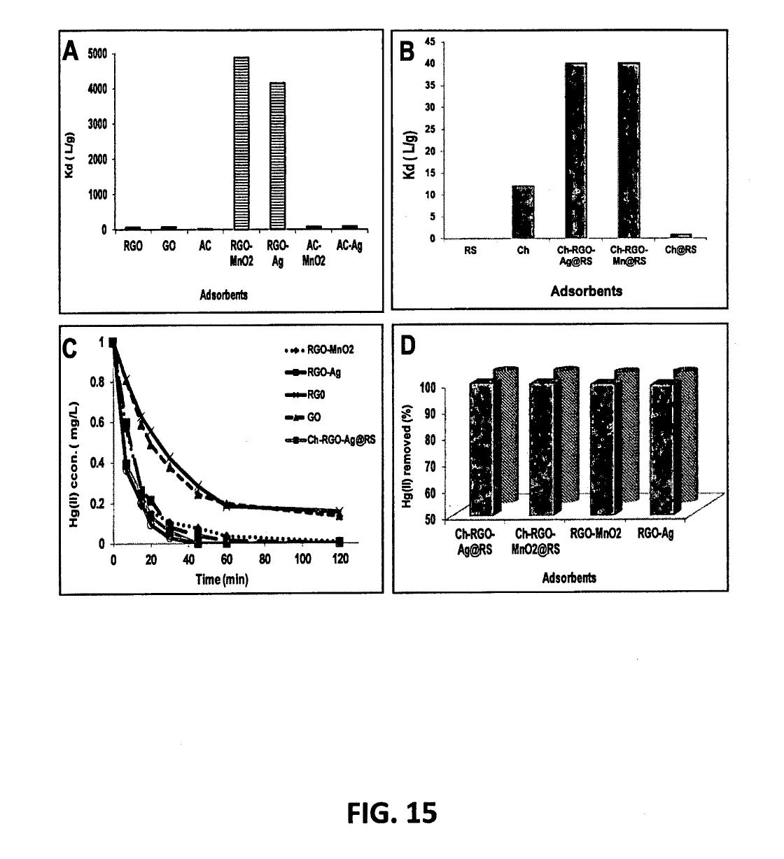

RGO, and its composites were tested for Hg(II) uptake. A few other adsorbents were also compared. Distribution coefficient, Kd is an important parameter to compare the affinity of a pollutant to an adsorbent. It is possible to compare the effectiveness of the adsorbent by comparing the magnitude of the Kd value. Higher the Kd value, the more effective the adsorbent material is. In general, the Kd values of *1 L/g are considered good, and those above 10 L/g are outstanding. The Kd values calculated at equilibrium clearly indicate that RGO-MnO₂ and RGO-Ag, both supported and unsupported forms, are excellent candidates for Hg(II) removal (FIGS. 15A and B). The RGO composites outperformed all other materials studied. The importance of RGO as a substrate is also well demonstrated. Kd values showed that the nanoparticles in supported state in graphene composites are 10 times better candidates. On close comparison of Kd value (without considering the weight of silica), we see that RGO-composites in the supported form are superior (4-5 times increase in Kd values) in removing Hg(II) compared to unsupported RGO-composites. This enhancement in affinity could be due to the synergetic effect arisen from the combination of materials.

Kinetic study was performed to understand the time dependent removal of Hg(II) by few selected adsorbents including GO, RGO, RGO-MnO₂, RGO-Ag, Ch-RGO-MnO₂@SILICA, and Ch-RGO-Ag@SILICA. FIG. 15C shows that all the tested materials are capable of adsorbing Hg(II) from water. Pristine RGO and GO showed similar kinetics of removal and did not show any significant variation in equilibrium uptake capacity. Compared to the parent material, RGO-composites showed higher removal kinetics and the system could remove Hg(II) completely from the aqueous medium. The RGO-composites supported on SILICA also showed higher uptake rate and it is superior to all other adsorbent materials tested.

To quantify the uptake rate, which is important in engineering design, the experimental kinetic data were analyzed with commonly used reaction kinetic models such as Lagergren pseudo-first-order (Lagrange, S. Zur theorie der sogenannten adsorption geloster stoffe K Sven.Vetenskapsakad. 1898, 24, 1).and Ho's pseudo-second-order (Ho, Y. S.; McKay, G. The kinetics of sorption of divalent metal ions onto sphagnum moss peat reaction rate models. Water Res. 2000, 34, 735.). Mathematical representations of these models are given below.

$$\begin{matrix}Pseudo \text{-} first \text{-} order equation \text{:} {q}_{t} = {q}_{e} ( 1 - {e}^{- {k}_{1} t} ) & ( 1 ) \\ Pseudo \text{-} second \text{-} order equation \text{:} {q}_{t} = \frac{{q}_{e}^{2} {k}_{2} t}{1 + {q}_{e} {k}_{2} t} & ( 2 )\end{matrix}$$

Where qe and qt are the adsorption capacity at equilibrium and at time t, respectively (mg/g). k1 is the rate constant of pseudo-first-order adsorption (1/min) and k2 is the rate constant of pseudo-second-order adsorption (g/mg min).

A non-linear approach was used to find the best-fitting model and kinetic parameters. The model predicted kinetic parameters and their associated error measurements show that pseudo-first-order equation is more appropriate in predicting the experimental data (FIG. 16). The pseudo-first order model predicted plots with experimental data are given in FIGS. 16A and 16B.

In order to evaluate the Hg(II) removal capability of the RGO-composites, both supported and unsupported in real water, a groundwater spiked with ˜1 mg/L of Hg(II) was prepared and tested for uptake. Control experiments were also conducted with ˜1 mg/L Hg(II) spiked distilled water. The results obtained from these experiments are shown in FIG. 15. The data clearly established that complete (below detectable limit) removal of Hg(II) happened in both the systems. The co-ions present in the real sample did not affect the removal, indicating that such a system can be employed for the applications of real water.

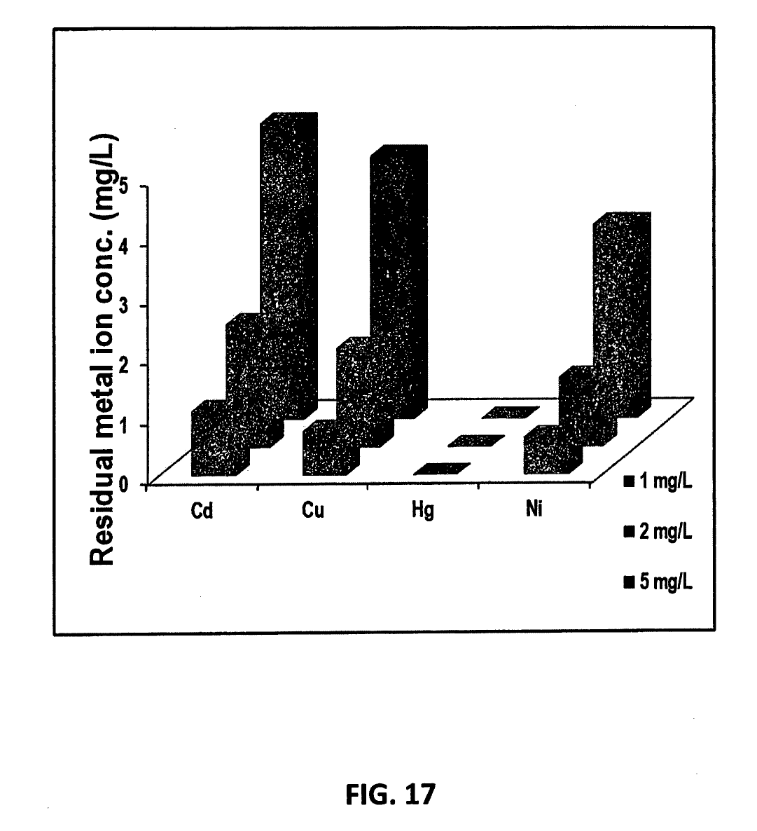

For checking the selectivity of the RGO-composites for Hg(II), batch adsorption experiments were conducted in distilled water by spiking a mixture of metal ions, including Hg(II), Ni(II), Cu(II) and Cd(II). Three sets of studies were conducted and each set of experiment was performed by using a mixture of aqueous solution of ˜1 mg/L, 2 mg/L and 5 mg/L each four metal ions motioned above. The selectivity data obtained for the RGO-Ag system is depicted in FIG. 17. The results reveal that RGO-Ag system is highly selective for the Hg(II) and the selectivity varied as per the order; Hg(II)<Cu(II)<Ni(II)<Cd(II). However, Hg(II) removal by RGO-MnO₂ system is significantly affected by the presence of other metal ions. The difference in selectivity pattern observed in the case of two composites may be due to difference in chemical selectivity of the metal/metal oxide used in the composites towards the target contaminants. MnO₂ is known to remove a wide range of cations and the main adsorption mechanism responsible for the removal is electrostatic interaction between the adsorbate and the adsorbent. Hence, a reduction in uptake of target contaminant (Hg(II)) is expected in presence of other cations. The selectivity of RGO-Ag system for Hg(II) may be due to the higher affinity of Ag towards Hg(II).

In summary, utilizing the reducing capacity of RGO, different metal/metal oxide composites were prepared. Based on different spectroscopic and microscopic evidences, the formation was established to be due a redox-like reaction between RGO and the metal precursor. The oxidation of RGO mainly results in GO and metal precursors are getting reduced into the corresponding nanoparticles which are attached onto the RGO sheets, as evident from TEM and SEM. Heavy metal scavenging capacity of the as prepared materials were demonstrated taking Hg(II) as the model pollutant. Considering the practical difficulty in applying nanomaterial for water purification, attempts were also made to immobilize the RGO composites on a cheap support like silica and the supported material was tested for Hg(II) uptake. The composite materials were found to be excellent candidates for Hg(II) removal from water.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A nanocomposite comprising reduced graphene oxide (RGO) and nanoparticles of at least one of a metal and an oxide of the metal, wherein the metal comprises at least one of gold, silver, platinum, palladium, cobalt, manganese, iron, tellurium, rhodium, ruthenium, copper, iridium, molybdenum, chromium and cerium.

2. The nanocomposite of claim 1, wherein the nanoparticles have a diameter of from about 1 nm to 100 nm.

3. (canceled)

4. The nanocomposite of claim 1, wherein the nanocomposite comprises at least one of: RGO-Ag, RGO-Au, RGO-Pt, RGO-Pd, RGO-Fe, RGO-Rh, RGO-MηO_{χ}, RGO-CoO, RGO-Te0₂, RGO-Ce₂0₃, RGO-Cr₂0₃.

5. The nanocomposite of claim 1, wherein the nanoparticles are non-spherical.

6. The nanocomposite of claim 1, wherein the nanoparticles are of a tetrahedron shape, a triangular shape, a prismatic shape, a rod shape, a hexagonal shape, a cubical shape, a ribbon shape, a tubular shape, a helical shape, a dendritic shape, a flower shape, a star shape, or a combination thereof.

7. The nanocomposite of claim 1, wherein the nanocomposite is capable of adsorbing one or more heavy metals from water.

8. (canceled)

9. The nanocomposite of claim 1, wherein the nanocomposite is supported on materials comprising at least one of alumina, zeolites, activated carbon, cellulose fibers, coconut fibers, clay, banana silks, nylon, or coconut shell.

10. An adsorbent comprising the nanocomposite of claim 1.

11.-15. (canceled)

16. An adsorbent comprising the nanocomposite of claim 1, wherein the nanocomposite is bound to a substrate.

17. The adsorbent of claim 16, wherein the substrate comprises at least one of silica, alumina, zeolites, activated carbon, cellulose fibers, coconut fibers, clay, banana silks, nylon, and coconut shell.

18. The adsorbent of claim 16, wherein the nanocomposite is bound to the substrate by using at least one of chitosan, polyaniline, polyvinyl alcohol, and polyvinylpyrrolidone (PVP).

19.-23. (canceled)

24. A filtering device, comprising the adsorbent of claim 16.

25.-26. (canceled)

27. The filtering device of claim 24, wherein the filtering device is one of a candle, a radial porous block, vertical porous block, a filter bed, a packet and a bag.

28. A method of making a nanocomposite, the method comprising: reducing a metal precursor by reduced graphene oxide (RGO).

29. The method of claim 28, wherein the metal precursor is reduced by the RGO at a temperature of up to about 40° C.

30. The method of claim 28, wherein the metal precursor is reduced in-situ by the RGO.

31. The method of claim 28, wherein the RGO is obtained by chemical, biological, physical, photochemical, or hydrothermal reduction of graphene oxide (GO).

32. The method of claim 31, further comprising simultaneously reducing the metal precursor and the GO.

33. (canceled)

34. The method of claim 28, wherein the metal precursor comprises one or more compounds of gold, silver, platinum, palladium, cobalt, manganese, iron, tellurium, rhodium, ruthenium, copper, iridium, molybdenum, chromium and cerium.

35.-39. (canceled)

40. A nanocomposite formed by the method of claim 28.

41.-46. (canceled)
